(19) United States
(12) Patent Application Publication
(10) Pub. No.: US 2008/0126433 A1
(43) Pub. Date: May 29, 2008

(54) File management device and computer-readable medium storing program

(75) Inventor: Takanobu Kuge, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/905,614

(22) Filed: Oct. 2, 2007

(30) Foreign Application Priority Data
Nov. 28, 2006 (JP) 2006-320930

(51) Int. Cl. G06F 17/30

(52) U.S. Cl. 707/200; 707/E17.002

(57) ABSTRACT

An attached file extractor extracts a file attached to a mail to store in an attached file storage, and adds a sender of the mail to the extracted file as a property. A contact destination searching unit refers to a contact destination table storage, and when the file attached to the mail is selected or the like, indicates a contact destination of the sender of the file.

This application is based on Japanese Patent Application No. 2006-320930 filed with the Japan Patent Office on Nov. 28, 2006, the entire content of which is hereby incorporated by reference.

### BACKGROUND OF THE INVENTION

1. Field of the Invention

The present invention relates to a file management device and a computer-readable medium storing a program.

2. Description of the Related Art

In US2005/0267890A1, there is disclosed a technique in which, in a case where a user who has viewed data such as a document registered in a database and wants to contact the writer of the data, a picked-up image can be obtained from a PC (personal computer) with an imaging unit that the writer uses so as to easily know the current status of the writer.

In the above-described related art, only whether or not the writer is working at the PC that he or she ordinarily uses can be checked as his or her current status based on the picked-up image, and no contact destination for actually contacting the writer can be presented.

### SUMMARY OF THE INVENTION

Therefore, an object of the present invention is to provide a file management device and a computer-readable medium storing a program enabling display of a contact destination of a sender and the like associated with a file.

A file management device according to an aspect of this invention comprises a detector for detecting an access to a file by a user, and an indicating unit for indicating a contact destination of a file sender associated with the file when the access to the file is detected by the detector.

Preferably, the detector detects the access to the file in response to an indication request from the user for the contact destination of the file sender.

Preferably, the file management device further comprises an associating unit for associating the file with the file sender.

More preferably, the file management device further comprises an extractor for extracting a file attached to an electronic mail, and the associating unit associates the file extracted from the electronic mail by the extractor with the sender of the electronic mail.

Furthermore, preferably, the file management device further comprises a searching unit for searching the contact destination of the file sender.

More preferably, the file management device further comprises a retainer for retaining a correspondence relation between the file sender and the contact destination, and the searching unit refers to a content retained by the retainer to search the contact destination of the file sender.

Alternatively, more preferably, the searching unit includes a whereabouts management unit for managing whereabouts information on each user acquired from any one of another device and another system, and the searching unit refers to a content managed by the whereabouts management unit to search the contact destination.

Preferably, the indicating unit indicates information on the sender other than the contact destination together.

In a computer-readable medium storing a program according to another aspect of this invention, the program is installed in an image processing device including a processor to make the processor execute detecting processing of detecting an access to a file by a user, and indication processing of indicating a contact destination of a file sender associated with the file when the access to the file is detected in the detecting processing.

According to the file management device of the present invention, an effect of enabling the contact destination to be appropriately indicated is brought about.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing one example of an entire configuration of a file management system according to an embodiment of the present invention.

FIG. 2 is a diagram showing one example of a hardware configuration of an MFP.

FIG. 3 is a block diagram for explaining one example of a functional configuration of an MFP 101 of the present embodiment.

FIG. 4 is a diagram for explaining one example of contents of a contact destination table.

FIG. 5 is a diagram showing one example of a display form when a list of files stored in an attached file storage 231 is displayed on a display 12.

FIG. 6 is a diagram showing one example of a screen displayed on display 12 when “information display” is selected on the screen of FIG. 5.

FIG. 7 is a diagram showing one example of a screen displayed on display 12 when “information search” is selected on the screen of FIG. 5.

FIG. 8 is a flowchart for explaining one example of a contact destination searching method in a second embodiment.

FIG. 9 is a flowchart for explaining one example of contents of processing of acquiring information from the MFP.

FIG. 10 is a flowchart for explaining one example of processing contents on the MFP side in a case where the information is acquired from the MFP.

FIG. 11 is a flowchart for explaining one example of contents of processing of acquiring information from a PC.

FIG. 12 is a flowchart for explaining one example of contents of processing of acquiring information from an entry and exit management system.

FIG. 13 is a flowchart for explaining one example of contents of processing of acquiring information from a schedule management system.

FIG. 14 is a diagram showing one example of contents of a table retaining a correspondence relation to a contact destination for each whereabouts in the second embodiment.

### DESCRIPTION OF THE PREFERRED EMBODIMENTS

Hereinafter, referring to the drawings, embodiments of the present invention will be described, exemplifying a case where an MFP (Multi Function Peripheral) is used as one example of equipment to which a file management device according to the present invention is applied.

### Embodiment 1

### 1. Configuration of File Management System

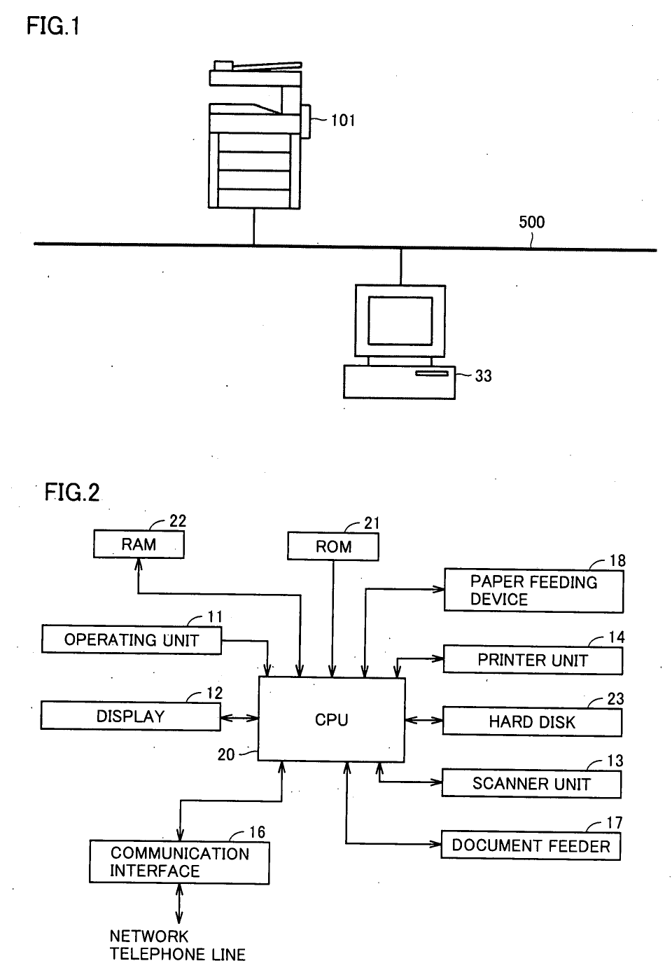

FIG. 1 is a diagram showing one example of an entire configuration of a file management system of the present embodiment. The file management system of the present embodiment is configured such that MFP 101 with a file management device of the present embodiment installed, a PC 31 and a mail server 33 are connected to a network 500 such as an LAN (Local Area Network).

MFP 101 of the present embodiment can receive an electronic mail (hereinafter, also referred to only as “mail”) transmitted from outside by specifying a mail address given to MFP 101 as a transmission destination mail address. More specifically, MFP 101 periodically sends mail server 33 download request of a mail transmitted to MFP 101 and download the same.

### 2. Configuration of MFP 101

Next, a configuration of MFP 101 is described. FIG. 2 is a diagram showing one example of a hardware configuration of MFP 101.

MFP 101 comprises an operating unit 11, a display 12, a scanner unit 13, a printer unit 14, a communication interface 16, a document feeder 17, a paper feeding device 18, a CPU 20, a ROM 21, a RAM 22, a hard disk 23 and the like.

Operating unit 11 includes a plurality of keys for inputting numeral characters, letters, signs and the like, a sensor that recognizes a pressed key, a transmission circuit that transmits a signal indicating the recognized key to CPU 20, and the like.

Display 12 displays a screen that displays a message to a user, a screen for the user to input setting contents and processing contents, a screen showing a result of processing executed in MFP 101, and the like. In the present embodiment, a touch panel making up part of operating unit 11 is provided on display 12. The touch panel has a function of sensing a position on the touch panel that the user has touched with his or her finger, and transmitting a signal indicating a sensing result to CPU 20.

Scanner unit 13 reads an image drawn on a manuscript with a predetermined reading resolution by irradiating the manuscript with light to detect reflected light, and generates digital image data (in this case, concentration data indicating concentrations of RGB or black).

The obtained image data is used for printing in printer unit 14, and in addition, is converted into a file in a format of TIFF, PDF, JPEG and the like to be stored in hard disk 23. It may be also converted into FAX data to be FAX-transmitted. Moreover, as described before, it may be attached to a mail to be transmitted outside. Document feeder 17 is provided, for example, on the top of a body of MFP 101, and is used to feed one or a plurality of sheets of manuscript to scanner unit 13 sequentially.

Printer unit 14 prints an image read in scanner unit 13, an image of data transmitted from an external device such as another MFP, which is connected through the network such as a LAN, or an image of FAX data received over FAX on a recording sheet such as paper or a film.

Paper feeding device 18 is provided, for example, in the bottom of the MFP 101 body, and is used to supply the recording sheet to printer unit 14. The recording sheet on which the image is printed by printer unit 14 is discharged, for example, onto a catch tray.

Communication interface 16 is an interface for performing communication with an external device such as PC 31 and a mail server 33 through the network such as the LAN and a WAN, or performing FAX transmission and reception through a telephone line. As communication interface 16, for example, an NIC (Network Interface Card), a TA (Terminal Adapter) and the like can be used.

In ROM 21, programs and data for realizing reading of an image (scanning), copying of a manuscript, transmission and reception of FAX data, network printing, and basic functions of MFP 101 such as a document server (box function) are stored. In addition, programs and data that realize the functions of the present embodiment are stored.

A part or whole of these programs or data may also be installed in hard disk 23 in advance. In this case, the programs and data installed in hard disk 23 are loaded on RAM 22 as necessary.

The functions described in the present embodiment can also be realized by using not only CPU 20 but also a dedicated hardware, or part of them can also be realized by utilizing a function of a general-purpose program of an operating system (OS) and the like.

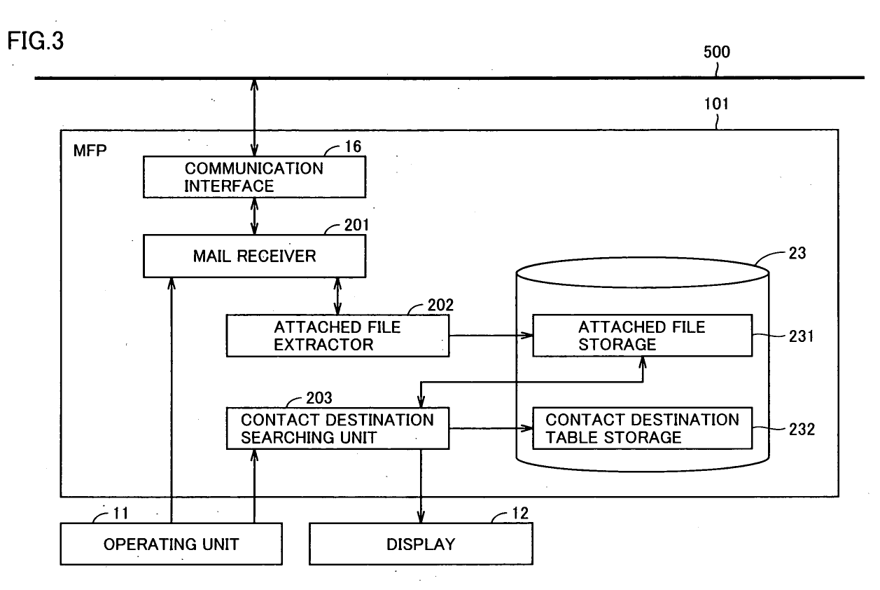

FIG. 3 is a block diagram for explaining one example of a functional configuration of MFP 101 of the present embodiment. MFP 101 comprises a mail receiver 201, an attached file extractor 202, and a contact destination searching unit 203. Functions of these respective units are realized by the programs stored in ROM 21 and RAM 22 being operated on CPU 20. Hard disk 23 includes attached file storage 231 and a contact destination table storage 232.

As to correspondence relations between FIG. 3 and the present invention, contact destination searching unit 203 corresponds to a “detector”, a “searching unit”, and a “whereabouts management unit”, display 12 corresponds to an “indicating unit”, attached file extractor 202 corresponds to an “associating unit” and an “extractor”, and contact destination table storage 232 corresponds to a “retainer”.

Mail receiver 201 downloads a mail transmitted from mail server 33 to MFP 101. Attached file extractor 202 extracts a file attached to the downloaded mail to store in attached file storage 231. In the present embodiment, a mail address of a sender of the mail is added to the extracted attached file as a property.

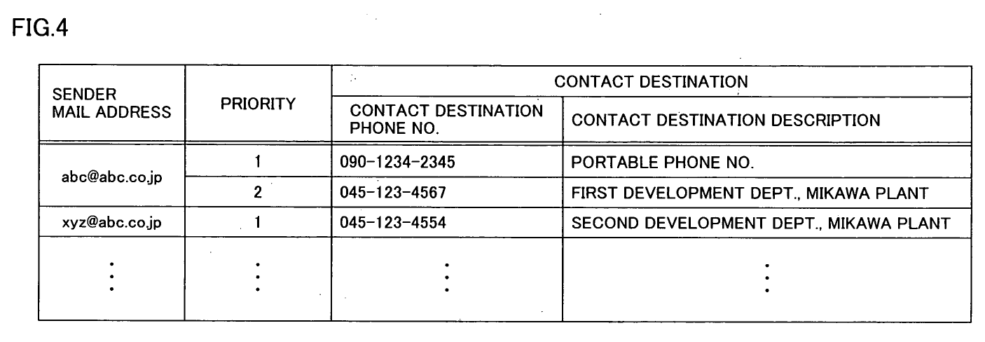

When the above-described extracted attached file is selected through operating unit 11, contact destination searching unit 203 searches a contact destination of the mail sender added to the relevant attached file. In the present embodiment, referring to contents of a contact destination table stored in contact destination table storage 232, the contact destination is searched. FIG. 4 is a diagram for explaining one example of contents of the contact destination table.

In the contact destination table, for example, the mail address of the sender, a contact destination phone number, and description of the contact destination can be retained. As the contact destination, information on a FAX number, a current mail address and the like as well as a phone number and a portable phone number can be retained. Priorities shown in this figure can be given in the order of higher possibility of contacting.

FIG. 5 is a diagram showing one example of a display form when a list of files stored in attached file storage 231 is displayed on display 12. In the example of this figure, an icon 121 of a file A, and an icon 122 of a file B are displayed. In icon 122 of file B, the mail address of the sender of the mail is added, and in the example of this figure, the entire icon is displayed by a dotted line, which indicates that the relevant mail address is added.

For the icon with the mail address added, the display form is not limited to the dotted line, but a shape, a color or the like of the icon can also be differentiated from that of another icon. In the present embodiment, by arranging a mouse pointer on icon 122 of file B with the mail address added to right-click the same, a window 123 is displayed.

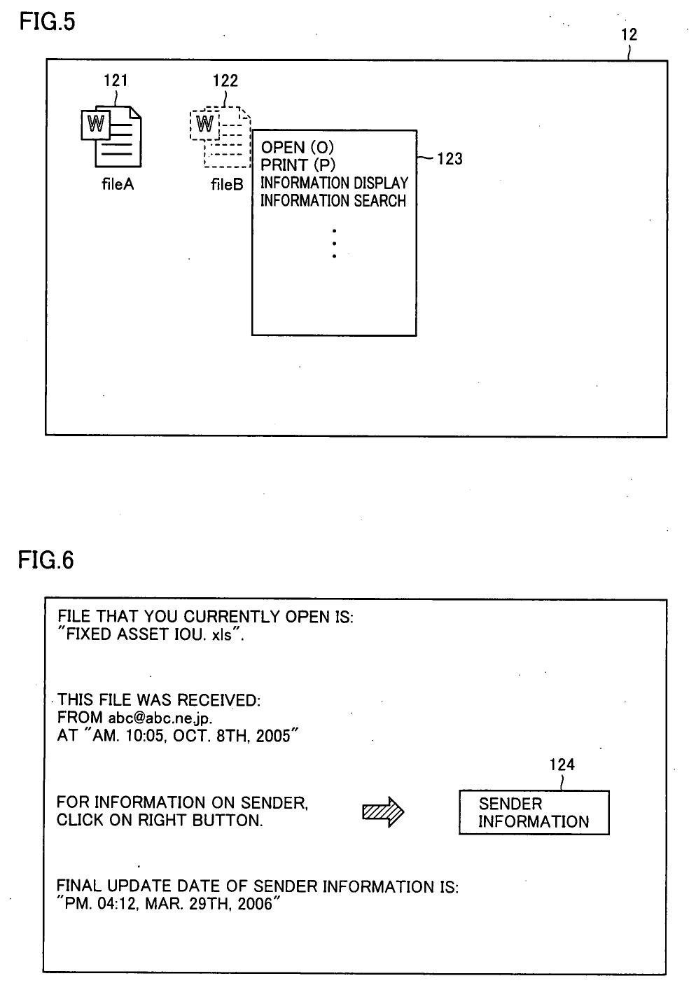

In window 123, in addition of ordinary items, items of “information display” and “information search” are displayed. When the “information display” is selected, the information on the added mail address is displayed on display 12. FIG. 6 is a diagram showing one example of a screen displayed on display 12 when the “information display” is selected.

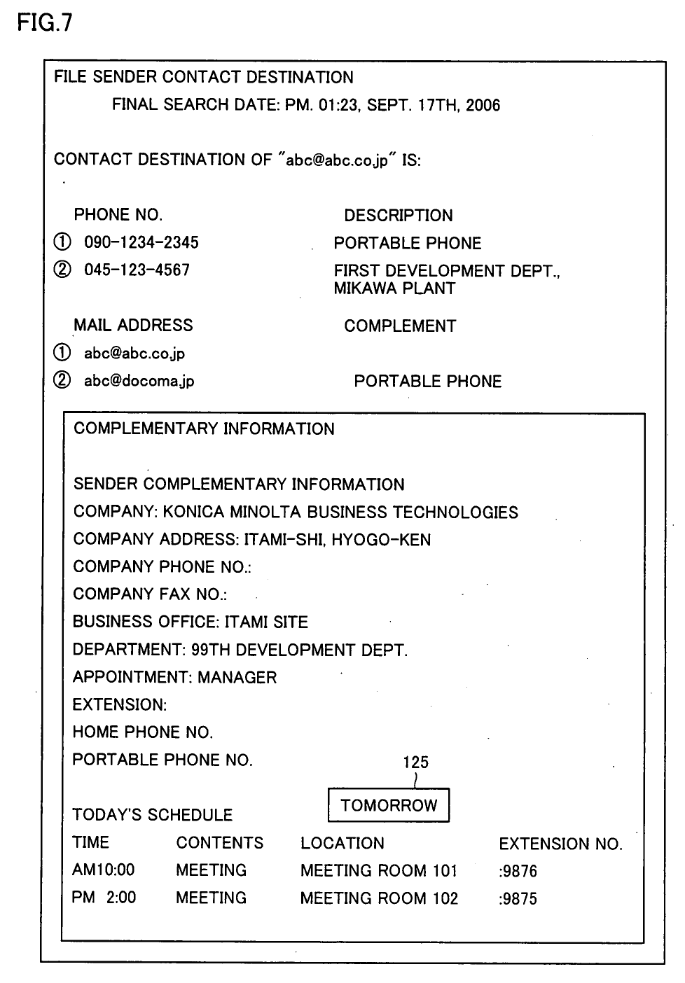

FIG. 7 is a diagram showing one example of a screen displayed on display 12 when the “information search” is selected. The screen of FIG. 7 is also displayed when a “sender information ” button 124 is pressed on the screen of FIG. 6. In the present embodiment, in this case, this is recognized as a sender contact destination indication request from a user, and the contact destination is displayed. Selecting the icon of the file by mouse click and the like may be sensed as the contact destination indication request to display the screen as shown in FIG. 7. Including such a case, the displayed information can also be only the contact destination.

In the screen of FIG. 7, for the mail address and complementary information (sender information, schedule information and the like), information managed in a database not shown separately can be taken out and displayed. Depending on contents of this database, displayable contents are wide-ranging. While the information search can be configured so as to start at the point when the file is selected, the timing of search start is not limited.

### Embodiment 2

While in the above-described embodiment, the contact destination of the sender is acquired by searching the contact destination table, a method for acquiring the contact destination of the sender is not limited to the method of referring to the table. In the present embodiment, forms in which another MFP, a PC and another system such as an entry and exit management system and a schedule management system are accessed to search the contact destination are described.

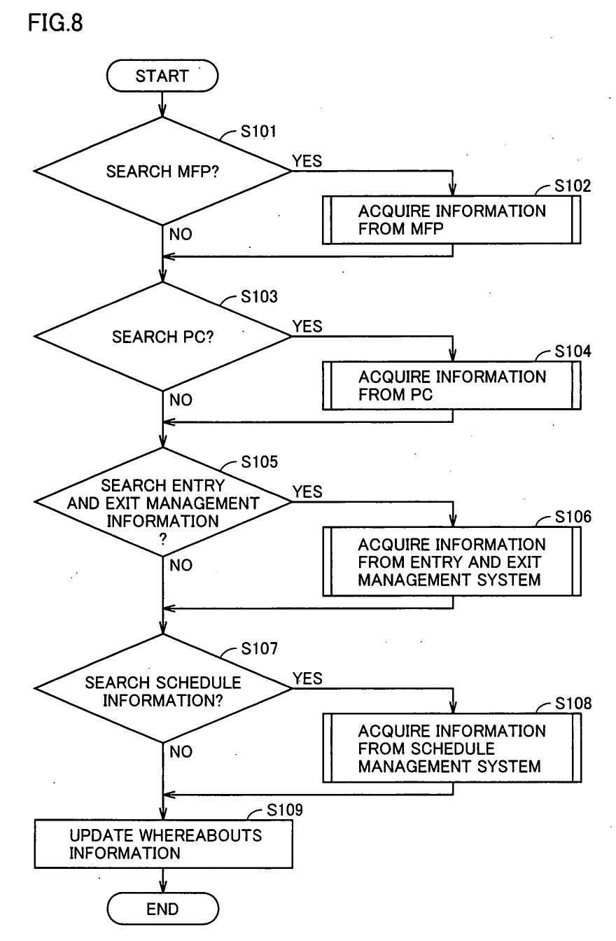

As a method for contact destination search of the present embodiment, communication with another MFP, communication with an information processing device such as a PC, communication with the entry and exit management system, communication with the schedule management system and the like can be considered. FIG. 8 is a flowchart for explaining one example of the contact destination searching method in the present embodiment. In the present embodiment, the processing explained by the flowchart is realized by CPU 20 executing a program corresponding to the processing.

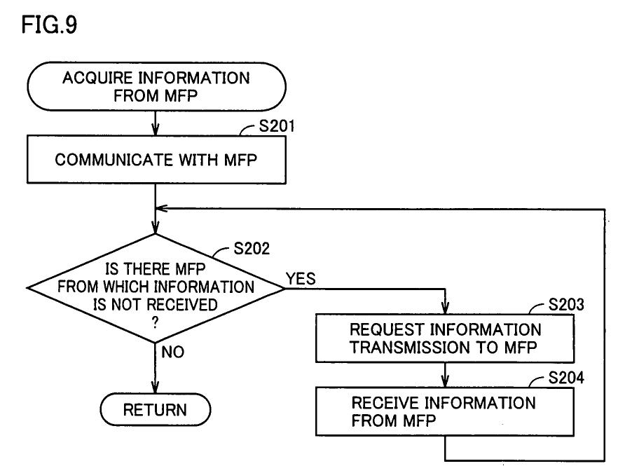

In the present embodiment, CPU 20 first determines whether or not another MFP exists (S101). This determination can be executed, for example, with reference to whether or not searching timing of the other MFP is applied. If the MFP is searched (S101: YES), CPU 20 communicates with another MFP to acquire the information (S102). FIG. 9 is a flowchart for explaining one example of contents of processing of acquiring the information from the MFP.

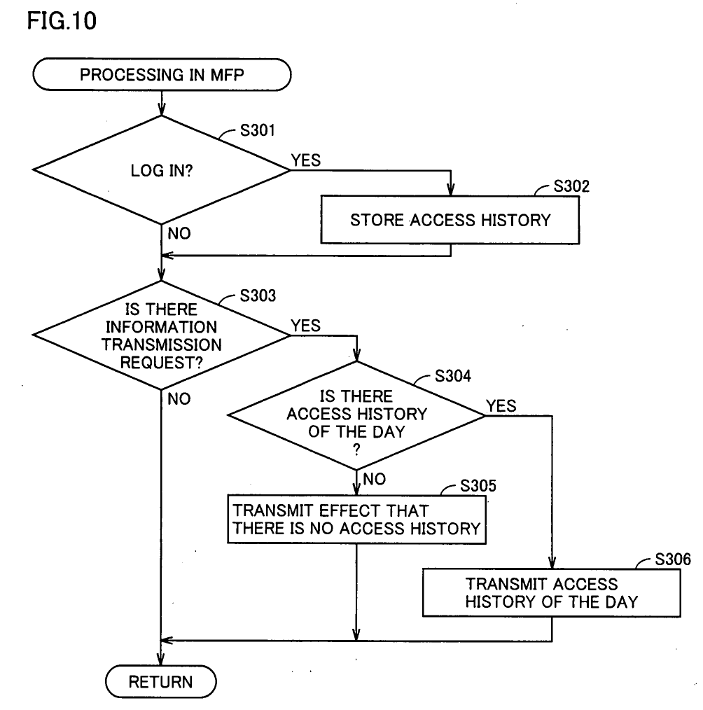

CPU 20 first communicates with another MFP (S201), and if any MFP from which information (access history) has not been received exists (S202: YES), then an information transmission request is made to the relevant MFP (S203) to receive the information (S204). FIG. 10 is a flowchart for explaining one example of processing contents on the MFP side in this case.

On the MFP side, when the user logs in (S301: YES), the access history of the user stores (S302). This access history can be the information for acquiring the appropriate contact destination of the user. If any information transmission request in the above step S203 exists (S303: YES), CPU 20 determines whether or not the access history of the day exists (S304), and if no access history of the day exists (S304: NO), the effect that there is no access history is transmitted (S305). If any access history exists (S304: YES), CPU 20 transmits the access history of the day (S306).

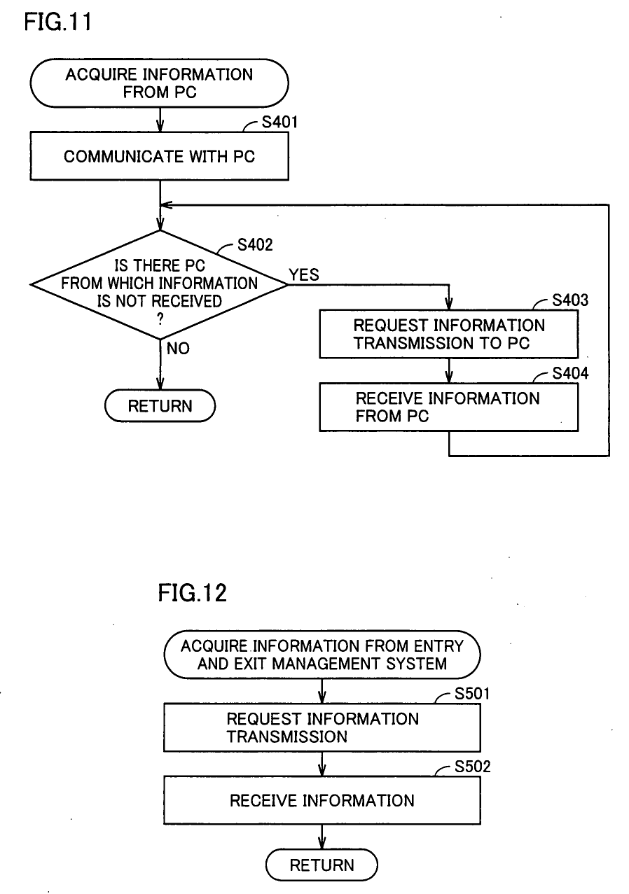

Referring back to FIG. 8, next, CPU 20 determines whether or not the PC search is to be performed (S103). If the PC search is performed (S103: YES), CPU 20 on the MFP side executing the search searches a PC connected through the network such as a LAN to acquire the information (S104). FIG. 11 is a flowchart for explaining one example of processing contents when the information is acquired from the PC.

CPU 20 first communicates with the PC (S401), and if any PC from which the information has not been received exists (S402: YES), CPU 20 makes an information transmission request to the relevant PC (S403) and receives the information (S404). On the PC side, a user logging in the relevant PC is managed, so that the side of the MFP receiving the information can acquire the ID of the logging-in user. The ID of the user logging in the PC can be used as the information, which is a basis of the appropriate contact destination search to the relevant user.

Referring back to FIG. 8, next, CPU 20 determines whether or not the search for the entry and exit management information is to be performed by communicating with the entry and exit management system (S105). If the search is performed (S105: YES), CPU 20 acquires the information from the entry and exit management system (S106). FIG. 12 is a flowchart for explaining one example of the processing contents when the information is acquired from the entry and exit management system.

Namely, CPU 20 makes an information transmission request to the entry and exit management system (S501) and receives the information (S502). The entry and exit management system manages an entry time and an exit time of a user, and the like, so that, with reference to the information acquired from the entry and exit management system, the whereabouts of the user can be known.

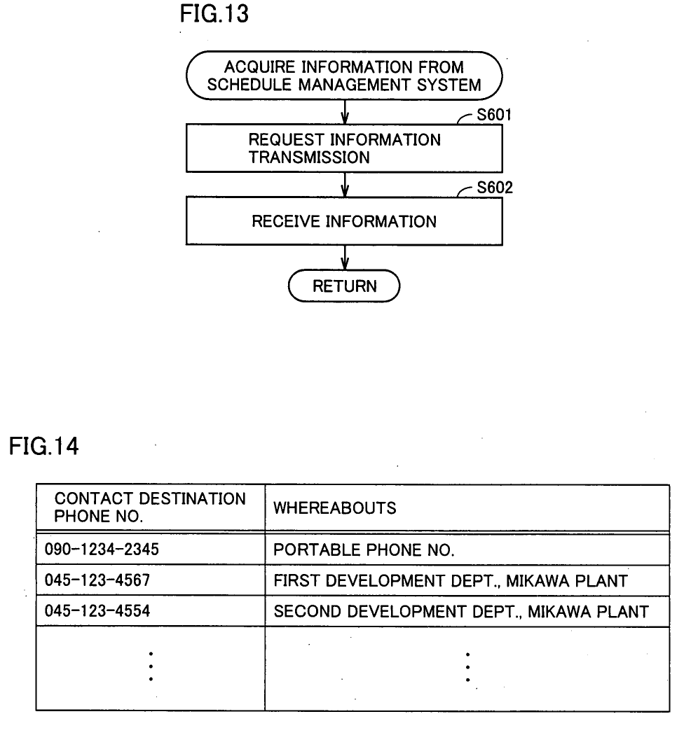

Referring back to FIG. 8, next, CPU 20 determines whether or not the schedule information on each user is to be searched (S107). If the schedule information is searched (S107: YES), CPU 20 acquires the information from the schedule management system (S108). FIG. 13 is a flowchart for explaining one example of processing contents when the information is acquired from the schedule management system.

Namely, CPU 20 makes an information transmission request to the schedule management system (S601) and receives the information (S602). The schedule management system includes information on the whereabouts of the user, so that, with reference to the relevant information, the MFP side having acquired the information can know the whereabouts of the user.

When the search processing described above is finished, CPU 20 updates the whereabouts information on each user (S109). In the present embodiment, referring to the whereabouts information on the user obtained by the search for the whereabouts information and a table retaining a correspondence relation to the contact destination for each whereabouts, one example of which is shown FIG. 14, the contact destination of the user can be acquired.

### Embodiment 3

While in the above-described embodiment, the configuration is such that when the file attached to the electronic mail is extracted, adding the address of the mail sender to the relevant file associates the file with the file sender, the association between both can be also performed in another case.

For example, in a case where the file is transferred between the MFPs, a configuration can be such that the information on the file sender (the logging-in user of the MFP on the transmission side) is transmitted as header information on an IP packet passing on the network to associate the file with the file sender on the receiving side.

Moreover, the association between the file and the file sender is not limited to a case where it is performed on the file management device side which has received the file, but the association with the file sender can also be performed in transmitting the file to the file management device. In this case, the information on the file sender (logging-in user at that time) can also added as a property of the file in transmitting the file.

### Modification

While as described above, the embodiments of the present invention have been described, it is obvious that the contents of the present invention are not limited to the specific examples described in the above-described embodiments, and for example, the following modification can also be carried out.

Namely, while in the above-described embodiment, a case where the file management device of the present embodiment is installed in MFP 101 has been described, the file management device can also be installed in the information processing device such as a PC. Moreover, an embodiment in which it is connected to MFP 101 by a dedicated cable and the like is also possible.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A file management device comprising:
a detector for detecting an access to a file by a user; and
an indicating unit for indicating a contact destination of a file sender associated with the file when the access to the file is sensed by said detector.

2. The file management device according to claim 1, wherein
said detector detects the access to the file in response to an indication request from the user for the contact destination of the file sender.

3. The file management device according to claim 1, further comprising:
an associating unit for associating the file with the file sender.

4. The file management device according to claim 3, further comprising:
an extractor for extracting a file attached to an electronic mail, wherein
said associating unit associates the file extracted from the electronic mail by said extractor with the sender of the electronic mail.

5. The file management device according to claim 1, further comprising:
a searching unit for searching the contact destination of said file sender.

6. The file management device according to claim 5, further comprising:
a retainer for retaining a correspondence relation between said file sender and the contact destination, wherein
said searching unit refers to a content retained by said retainer to search the contact destination of said file sender.

7. The file management device according to claim 5, wherein
said searching unit includes a whereabouts management unit for managing whereabouts information on each user acquired from any one of another device and another system, and
said searching unit refers to a content managed by the whereabouts management unit to search the contact destination.

8. The file management device according to claim 1, wherein
said indicating unit indicates information on said sender other than the contact destination together.

9. A computer-readable medium storing a program, said program being installed in an image processing device including a processor to make the processor execute:
detecting processing of detecting an access to a file by a user; and
indication processing of indicating a contact destination of a file sender associated with the file when the access to the file is sensed in said detecting processing.
